(19) United States
(12) Patent Application Publication
(10) Pub. No.: US 2023/0057908 A1
(43) Pub. Date: Feb. 23, 2023

(54) CONDUCTIVE NANOCOMPOSITES WHICH CAN BE FUNCTIONALIZED

(71) Applicant: Leibniz-Institut für Neue Materialien gemeinnützig GmbH, Saarbrücken (DE)

(72) Inventors: Indra Backes, Saarbrücken (DE); Andreas Hegetschweiler, St. Ingbert (DE); Lola González-García, Saarbrücken (DE); Tobias Kraus, Saarbrücken (DE); Aránzazu del Campo, Mainz-Bretzenheim (DE); Aleeza Farrukh, Irvine, CA (US); Thibaut Thai, Montesson (FR)

(21) Appl. No.: 17/784,141

(22) PCT Filed: Dec. 4, 2020
(86) PCT No.: PCT/EP2020/084627

§ 371 Date: Jun. 10, 2022

(30) Foreign Application Priority Data
Dec. 20, 2019 (DE) 10 2019 135 645.8

(51) Int. Cl. C09D 7/62; C09D 11/52; C09D 5/24; C08L 41/00

(52) U.S. Cl. CPC C09D 7/62; C09D 11/52; C09D 5/24; C08L 41/00; B82Y 30/00

(57) ABSTRACT

A composition includes at least one type of conductive or semiconductive nanostructures, wherein at least one conductive ligand is arranged on the surface of the nanostructures, and at least one solvent, wherein the ligand has at least one group by which functionalization is possible. This makes it possible in simple fashion to obtain functionalizable conductive structures, in particular by inkjet processes.

Conductive Structures on Surfaces Play a Major Role in microelectronics. However, the processes for producing and structuring such structures are often very complex.

Recent years have seen increasing research into systems where such structures can be applied to surfaces by printing processes. Such wet coating processes can be used in a much more versatile way than the commonly used photolithographic processes.

Such processes require conductive inks, which often contain conductive particles, particularly nanoparticles.

Suspensions containing corresponding nanoparticles are used for this purpose. Once applied to a surface the solvent evaporates and the particles come into contact, thus making it possible to attain a conductive coating. However, especially in the case of nanoparticles the suspensions must also contain stabilizers which prevent aggregation of the nanoparticles. These form an organic coating on the surface of the nanoparticles. This is often not conductive. A thermal treatment is therefore necessary for such suspensions in order to remove the stabilizers from the surface of the nanoparticles.

Although organic solvents often have low boiling points, solvents such as water, alcohols or mixtures thereof are preferable, if only for reasons of cost. However, this makes it necessary for the suspensions to be stable in these solvents too.

There is simultaneously a need to endow the conductive inks with additional functions, particularly in the biological field. This is not possible with conventional inks.

### Problem

The problem addressed by the present invention is that of specifying a composition which allows simple production of conductive structures on surfaces which can be functionalized in simple fashion. Also to be specified are a process for producing such a composition and a process for producing conductive structures with such compositions.

### Solution

This problem is solved by the inventions having the features of the independent claims. Advantageous developments of the inventions are characterized in the dependent claims. The wording of all claims is hereby made part of the content of this description by reference. The inventions also comprehend all reasonable and in particular all recited combinations of independent and/or dependent claims.

The problem is solved by a composition for producing conductive layers by wet coating (=ink), comprising
a) at least one type of conductive or semiconductive nanostructures, wherein at least one conductive ligand is arranged on the surface of the nanostructures;
b) at least one solvent, wherein the ligand has at least one functional group by means of which functionalization is possible.

The nanostructures are preferably inorganic nanostructures. Metallic nanostructures which comprise a metal, mixtures of two or more metals or an alloy of two or more metals may be concerned. The metals are preferably selected from gold, silver, copper, platinum, palladium, nickel, ruthenium, indium or rhodium. The nanostructures may also include conductive or semiconductive oxides. Examples of such oxides, which may also be doped, include indium tin oxide (ITO) or antimony tin oxide (ATO). They may also be semiconductors of groups II-VI, III-V or IV or alloys of such semiconductors. Examples include CdS, CdSe, CdTe, InP, InAs, ZnS, ZnSe, ZnTe, HgTe, GaN, GaP, GaAs, GaSb, InSb, Si, Ge, AlAs, PbSe or PbTe.

Metallic nanostructures comprising gold, silver, copper, platinum, palladium, nickel, ruthenium, indium or rhodium or mixtures or alloys thereof are preferred. Nanostructures made of gold are particularly preferred.

The structures concerned here are nanostructures. This is to be understood as meaning that the structures involved have an extent of less than 200 nm (measured by TEM) in at least one, preferably in at least two, particularly preferably in all dimensions. Particles, in particular spherical particles, may also be concerned. The nanostructures can also have different extents in different dimensions. Examples include nanowires, which have a ratio of the longest dimension to each of the other two dimensions of at least 1.5, preferably at least 2. Spherical particles are preferred. Preferably having a diameter of less than 150 nm, in particular less than 100 nm, particularly preferably having a diameter of 50 nm to 150 nm, in particular 60 nm to 110 nm (determined by TEM)

The ligand is preferably a conductive polymer whose polymer backbone adsorbs onto the nanostructures either through its conjugated pi-system or through a functionality directly in or in the immediate vicinity of the conductive polymer backbone. To ensure increased stability the conductive polymer is a polymeric or oligomeric structure comprising at least 10 bonding sites. These bonding sites make it possible to achieve a coordinative bond to the surface of the nanostructure, preferably are bonded thereto. The ligand is moreover characterized in that it comprises at least one side chain not belonging to the conjugated pi system. Through suitable choice of these side chain(s): polar groups to ensure colloidal stability in polar solvents and sterically demanding nonpolar side chains to ensure colloidal stability in nonpolar solvents.

At least one side chain is chosen so as to allow functionalization by means of it.

A bonding site is to be understood as meaning the formation of an at least coordinative bond to the surface of the nanostructure. This is preferably effected by means of heteroatoms such as O, N, Se or S, especially S. Especially for metallic surfaces sulfur is the preferred bonding site.

The conductive ligand therefore preferably comprises a conductive polymer. These are polymers having a conjugated pi system as the backbone.

Such conductive polymers are for example was based on pyrrole such as polypyrrole, poly(N-substituted pyrrole), poly(3-substituted pyrrole) and poly(3,4-substituted pyrrole); thiophene such as polythiophene, poly(3-substituted thiophene), poly(3,4-substituted thiophene), polybenzothiophene, polyisothionaphthene, polyfurans, polybenzofurans, polycarbazoles, polyselenophenes, polyindoles, polypyridazines, polyanilines, polymethoxyphenylenes. The polymers may also be copolymers or block copolymers with other monomers.

Preferred polymers are polythiophenes, polypyrroles except poly(N-substituted pyrrole), polyfurans, polybenzofurans, polybenzothiophenes, polycarbazoles, preferably polythiophenes such as polythiophene, poly(3-substituted thiophene), poly(3,4-substituted thiophene) and polybenzothiophene. In these polymers the heteroatoms of the monomers form the bonding sites to the surface of the nanostructure. In the case of at least 10 bonding sites the polymer or oligomer has at least 10 monomer units. Ligands having at least 50, in particular at least 100, bonding sites are preferred. Preferably independently thereof the ligand comprises not more than 2000, in particular not more than 1500, bonding sites. A bonding site preferably corresponds to a monomer of a polymer and/or oligomer.

Examples of further monomers in case the ligand comprises further monomers are for example styrenesulfonic acid or polystyrenesulfonic acid.

Examples of thiophenes are ethylene-3,4-dioxythiophene, 2-(3-thienyl)ethoxy-4-butylsulfonate (for example as the sodium salt), 3-hexylthiophene or the corresponding polythiophenes poly(ethylene-3,4-dioxythiophene), poly(2-(3-thienyl)ethoxy-4-butylsulfonate), poly(3-hexyl)thiophene.

The side chain of the ligand may for example comprise at least one polar group which increases compatibility with polar solvents. Examples of such groups are amino groups, hydroxyl groups, carboxyl groups, ester groups, halogens, thiols, ether groups, thioether groups, sulfate groups, sulfonic acid groups, amide groups, nitro groups, cyano groups, phosphonate groups. The side chain is preferably an aliphatic branched or unbranched carbon chain comprising 4 to 25 carbon atoms, wherein one or more nonadjacent CH₂ groups may be substituted by 0, NR or S, wherein R is hydrogen or an aliphatic radical having 1 to 10 carbon atoms which comprises at least one polar group as a substituent.

The ligand can also comprise more than one polar group. At least 5 polar groups per ligand are preferred.

At least one functional group per ligand is preferred. It is preferable when such groups are present such that the ligand has a net charge in a pH range between 6 and 10. There may also be at least one functional group per monomer.

The polar group is preferably a carboxyl group. Depending on the pH, the group may also be present at least partially as a carboxylate.

In a preferred embodiment the side group contains no sulfur atom. This includes thioethers, thiols but also sulfate groups or sulfonic acid groups. Said side group therefore does not bond to the nanostructure in contrast to the thiophene. The bonding to the nanostructure, preferably made of gold, is effected via the thiophene groups of the polymer or oligomer.

The polymer or oligomer is preferably a thiophene which preferably has a side chain bearing the functional group, preferably the carboxyl group, at the 3-position. The side chain is preferably an aliphatic chain having 3 to 8 carbon atoms, preferably having 6 carbon atoms, wherein the carboxyl group counts as a carbon atom. The functional group is preferably arranged at the end of the side chain.

In a preferred embodiment the polymer is selected from poly[3-(potassium-4-butanoate)thiophene-2,5-diyl], poly[3-(potassium-5-pentanoate)thiophene-2,5-diyl], poly[3-(potassium-6-hexanoate)thiophene-2,5-diyl] or poly[3-(potassium-7-heptanoate)thiophene-2,5-diyl], particularly preferably poly[3-(potassium-6-hexanoate)thiophene-2,5-diyl].

The ligand is preferably a polymer or oligomer having an average molecular mass of at least 5 kDa, preferably not more than 1000 kDa (measured by gel permeation chromatography), preferably of at least 10 kDa to 500 kDa, in particular of 30 kDa to 100 kDa.

The proportion of the nanostructures is preferably at least 10% by weight, in particular at least 30% by weight, based on the composition without solvent. The proportion of the nanostructures may be up to 90% by weight. Preferred proportions are 10% by weight to 90% by weight, in particular 20% by weight to 80% by weight, very particularly 30% by weight to 70% by weight.

The content of nanostructures in the composition is preferably 50 to 200 mg/ml based on the nanostructure, in the case of a metallic nanostructure on the metal, in particular on gold. A content of 90 to 160 mg/ml, very particularly 100 to 150 mg/ml, is preferred. It was surprising that it was possible, particularly in the particularly preferred embodiments, to obtain a colloidally stable composition in water and in alcohols.

The ligand has at least one group by means of which functionalization is possible. This is preferably the above-described functional and/or polar group of the sidechain. This group is preferably a carboxyl group.

The carboxyl group in particular allows bonding via very different reactions. Accordingly, functionalization as an ester may be effected by reaction with alcohols, as an amide by reaction with an amine, as an anhydride by reaction with a carboxylic acid.

The functionalization may be carried out under physiological conditions. This applies in particular to reaction with amines. Many biological molecules, especially proteins and peptides, bear such groups or can be produced in such a way as to bear at least one such group.

For the reaction it may be necessary to activate the carboxyl group. Methods therefor, for example reaction with EDC (1-ethyl-3-(3-dimethylaminopropyl)carbodiimide hydrochloride) or NHS (N-hydroxysuccinimide), are known to those skilled in the art and are standard for functionalization in biochemistry.

This makes it possible for the composition according to the invention to be functionalized in a very wide variety of ways.

Examples of such functionalizations are polymers, oligomers, peptides, proteins, antibodies, cells, oligonucleotides from DNA, RNA or analogs thereof, polysaccharides or glycosamines.

The peptides may be peptide sequences having up to 20 amino acids such as RGD or polymers such as polylysines such as PDL or PLL, poly-DL-ornithine.

The proteins can have very different functions. They may be growth factors such as EGF or interleukins, matrix proteins such as collagen.

The polysaccharides or glycosamines may be cellulose or heparin.

The functionalization may also be used, at least in part, for bonding the modified nanostructures to a substrate. This may be achieved by functionalizing the substrate with amino groups for example. This allows simple fixing of the ink.

The solvent is preferably selected from solvents or solvent mixtures composed of solvents each having a boiling point below 120° C. Such solvents allow the solvent to be removed quickly at low temperatures, for example of below 60° C.

The solvent is preferably a volatile solvent, especially a solvent volatile at room temperature.

Examples of such solvents are water, alcohols, ketones or ethers and mixtures thereof. Further solvents may be present.

The further solvent may for example be selected from alkanes, aromatics and heteroaromatics, cyclic aromatics, esters, ketones, amides, sulfonates.

The solvent may comprise at least one alcohol. The at least one alcohol is preferably an alcohol comprising up to 10 carbon atoms. Examples of such alcohols are methanol, ethanol, n-propanol, isopropanol, n-butanol, i-butanol, 2-butanol, tert.-butanol, 1-pentanol, 2-methyl-1-butanol, 3-methyl-1-butanol, hexanol, heptanol, octanol, 1-octanol, 1-nonanol, 1-dekanol, allyl alcohol, crotyl alcohol, proparyl alcohol, cyclopentanol, cyclohexanol, 2-methoxyethanol, 2-ethoxyethanol, 2-butoxyethanol, ethylene glycol, propylene glycol.

Examples of ketones are acetone, methyl ethyl ketone, methyl isobutyl ketone.

Examples of esters are ethyl acetate, methyl acetate, propyl acetate, butyl acetate, ethyl butyrate, methyl butyrate, ethyl propionate, methyl propionate, propyl propionate.

Particularly preferred solvents are selected from water, alcohol or mixtures comprising water and/or at least one alcohol.

The solvent is preferably an alcohol, in particular methanol, ethanol, n-propanol, isopropanol, n-butanol, particularly preferably ethanol, i-propanol or n-propanol, very particularly preferably n-propanol. Mixtures can also be used.

The nanostructure modified with the polymer or oligomer preferably has a zeta potential of +/−20 mV in water. It is preferable when the nanostructure is redispersible in water, i.e. the nanostructure is stable in water for over 1 week.

The invention further relates to a process for producing the composition according to the invention.

This is achieved by performing a process comprising the steps of:
a) provision of a dispersion of conductive or semiconductive nanostructures, wherein the dispersion is stabilized by at least one first ligand;
b) addition of at least one conductive ligand;
c) substitution of the first ligand by the at least one conductive ligand.

Individual process steps are more particularly described hereinbelow. The steps need not necessarily be performed in the specified sequence and the process to be described may also provide further steps.

In this process a nanostructure having a conductive ligand on the surface is produced or a nanostructure whose nonconductive ligand present on the surface is substituted by a conductive ligand. The colloidal stability of the dispersion must not be impaired. Aggregation of the nanoparticles otherwise occurs.

In the case of ligand substitution a dispersion of conductive or semiconductive nanostructures which is stabilized by at least one first ligand is initially provided. Suitable nanostructures are those described for the compositions.

The dispersion is stabilized by at least one first ligand. This means that the dispersion remains stable under the conditions of the ligand substitution. The concentration of excess of this ligand may therefore be above 20 μM but below 10 mM, preferably between 30 μM to 1 mM, in particular between 50 μm to 800 μM.

The at least one first ligand preferably comprises at least one group for coordination with the surface of the nanostructure. This allows it to form the necessary surface layer which prevents aggregation of the structures. The ligand is preferably not covalently bonded.

Examples of such ligands are ligands comprising carboxylic acid groups, ammonium groups such as tetraalkylammonium groups and amino groups. Examples of such first ligands are citrates or cetyltrimethylammonium bromide (CTAB).

It may be necessary to remove any excess of a first ligand. This may be done for example by centrifugation and redispersion. It is important that colloidal stability is ensured.

The aggregation of the particles in the dispersion especially occurs only upon removal of the solvent. Compositions according to the invention are preferably stable, i.e. no aggregation detectable by UV-vis, for at least 24 hours, in particular at least 1 week, very particularly at least 1 month.

The nanostructures are preferably incubated with the at least one conductive ligand for at least 1 hour, particularly preferably at least 5 hours. At least 12 hours are preferred. The duration may be 5 hours to 200 hours, in particular 150 to 180 hours, in particular 160 to 180 hours, very particularly from 168 to 192 hours.

This effects substitution of the first ligand by the at least one conductive ligand; complete replacement is preferred.

The incubation is preferably performed at temperatures between 30° C. and 50° C. Excessively low temperatures favor agglomeration of the nanostructures.

Excessively short incubation result in incomplete substitution. Residues of the first ligand can lead to agglomeration during concentration. Excessively prolonged incubation can result in reagglomeration of the conductive ligand.

Once substitution has been carried out it may be necessary to remove unadsorbed ligands. To this end the dispersion may be purified and concentrated by centrifugation and discarding of the supernatant. The solvent can also be substituted in this step, in particular may be chosen for the composition of the ink. The dispersion should not be allowed to dry out. The particles modified with the ligand preferably always remain wetted with solvent.

The concentration ratio of polymer to nanostructure during the ligand substitution is preferably 0.5:1 to 1:1.5 (based on the mass concentration), preferably 0.5:1 to 1:1, in particular 0.7:1 to 0.9:1.

In the ligand substitution according to the invention the polymer preferably attaches to the nanostructure in at least one layer, preferably at least 2 layers, particularly preferably 2 to 6 layers (measured by thermogravimetric analysis). It is preferable when more than a monolayer is formed. In the particularly preferred embodiment the innermost thiophenes and the gold surface are bonded while the other layers bond to the thiophenes below via pi-pi interactions. Nevertheless, a multilayer structure has more functional groups, which provide colloidal stabilization for the modified nanostructure and/or are available for functionalization, available per unit area. The nanostructure is therefore preferably completely covered with the polymer.

Preference is therefore given to a ligand density of the modified nanostructure of at least 2 mg/m², preferably of at least 3 mg/m², in particular of 2 mg/m² to 5 mg/m².

In a preferred embodiment of the invention the dispersion is purified by one more centrifugations. The desired solvent is in each case added between the steps to reobtain a dispersion.

Preference is given to at least 3, in particular at least 5, centrifugation steps.

The speed of the centrifugation may be adapted to the composition. A centrifugation at below 1000 rpm for at least 4, in particular of 4 to 15 hours, is preferred.

In a particularly preferred embodiment at least one centrifugation is preceded by addition of a surfactant, preferably in an amount of 0.02% to 0.1% by weight (based on the dispersion). This makes it possible to perform centrifugation at higher speeds and for shorter durations without agglomeration. The surfactant is re-added for each centrifugation.

The surfactant is preferably soluble in the solvent used. A nonionic surfactant based on polysorbates is preferred. These may be mono- or tri-esters of lauric acid, palmitic acid, stearic acid or oleic acid, especially obtainable under the trade name Tween. Preference is given to [polyoxyethylene(20) sorbitan monolaurate] (Tween® 20), [polyoxyethylene(4) sorbitan monolaurate] (Tween® 21), [polyoxyethylene(20) sorbitan monopalmitate] (Tween® 40), [polyoxyethylene(20) sorbitan monostearate] (Tween® 60), [polyoxyethylene(20) sorbitan tristearate] (Tween® 65), [polyoxyethylene(20) sorbitan monooleate] (Tween® 80), [polyoxyethylene(5) sorbitan monooleate] (Tween® 81) and [polyoxyethylene(20) sorbitan trioleate] (Tween® 85), preferably [polyoxyethylene (20) sorbitan monolaurate].

In this embodiment no new surfactant is added in the final centrifugation step. This allows simple re-removal thereof.

Addition of the surfactant makes it possible to centrifuge the composition at higher speeds without agglomeration. It is preferable when the composition is centrifuged at least 1.5 times as fast as under the conditions without surfactant where no agglomeration occurs. It is simultaneously possible for centrifugation to be carried out for a shorter duration, in particular at least 0.8 times shorter, than without surfactant.

In a preferred embodiment the surfactant is centrifuged at at least 1000 rpm, in particular at 1500 to 2500 rpm.

It may also be advantageous perform at least one filtration step between the centrifugation steps.

The invention further relates to a modified nanostructure obtained by the process according to the invention for ligand substitution. The modified nanostructure preferably corresponds to the nanostructures according to the invention on whose surface at least one conductive ligand is arranged, in particular in the embodiments described as preferable therein.

This is preferably a modified nanostructure which is modified with the polymer or oligomer according to the invention. A modification with more than one layer of polymer or oligomer is preferred.

In a preferred embodiment the modified nanostructure is a gold nanostructure and the oligomer or polymer is a thiophene-based oligomer or polymer.

The invention also relates to a process for producing a functionalized conductive or semiconductive layer on a surface comprising the steps of:
a) application of a composition according to the invention to a surface,
b) removal of the at least one solvent,
c) functionalization of the composition.

The functionalization may also be carried out before the application. It should be noted that the particles also retain colloidal stability during the functionalization.

Individual process steps are more particularly described hereinbelow. The steps need not necessarily be performed in the specified sequence and the process to be described may also provide further steps.

In a first step the composition according to the invention is applied to a surface. This may be achieved by all of the processes for wet coating that are known to those skilled in the art. This may be achievable for example by inkjet printing, spraying, immersing, flowcoating, spraying, spin-coating, doctor blade coating. The required concentration of the dispersion, the solvent and possible additives may be chosen according to the type of application. The viscosity too may be adapted accordingly.

Preferred solvents are the solvents as described for the composition.

The material of the surface should be compatible with the composition employed, in particular of the solvent. The low temperatures allow the material of the surface to be selected freely. The surface may be an organic or inorganic surface. It may comprise for example plastics, metals, metalloids, glass or ceramic.

Due to the conductivity of the ligand any sintering steps for establishing conductivity are omitted. The surface may also be functionalized directly. The entire ink is also modified which results in a very high density of functionalization.

In a preferred embodiment of the invention the removal of the at least one solvent is carried out at a temperature of below 60° C., in particular below 40° C. Temperatures between 4° C. and 30° C. are preferred.

It is also possible to apply negative pressure, in particular below 1 bar.

The use of a conductive ligand means that removal of this ligand to establish the conductivity of the coating is not necessary. The ligand allows simple exchange of electrons between the particles. The functional group simultaneously allows simple functionalization.

In a preferred embodiment the process comprises no treatment of the coating at temperatures of more than 60° C., in particular more than 40° C., after the application to the surface. However, a temperature which is sufficient for removing the solvent, preferably at least 15° C., is preferred.

The invention further relates to functionalized conductive or semiconductive structures obtained with the process according to the invention.

The structure may be used in a very wide variety of ways depending on its functionalization. Especially as a sensor where conductivity is measured as a function of an interaction of the functionalization.

The functionalization can also be used for producing surfaces on which cells may be cultivated. This also makes it possible to achieve a contacting of cells.

The functionalization may especially be used to identify particular analytes. This is achievable for example via a corresponding bonding of a corresponding enzyme, antibody or protein which allows detection of a signal upon bonding and/or reaction of the analyte.

The term “enzyme” as used herein is a term of broad scope and is to be understood as having its normal and customary definition for a person with ordinary skill in the art and relates without limitation to a protein or a molecule based on a protein which accelerates a chemical reaction which preferably occurs in a living organism. Enzymes can function as catalysts for an individual reaction and can convert a reactant (also known as an analyte here) into a specific product. One exemplary embodiment of a glucose oxidase-based glucose sensor, an enzyme, comprises providing glucose oxidase(GOX) which reacts with glucose (the analyte) and oxygen to afford hydrogen peroxide.

The term “analyte” as used here is a term of broad scope which is to be understood as having its normal and customary definition and relates without limitation to a substance or a chemical constituent in a liquid, preferably a biological fluid (for example blood, sweat, saliva, tears, interstitial fluid, cerebrospinal fluid, lymphatic fluid or urine) which may be analyzed. The structures produced according to the invention, optionally after functionalization, may preferably be used for analysis of these biological fluids. The analytes may include naturally occurring substances, artificial substances, metabolites and/or reaction products. In a number of embodiments the analyte for measurement with the sensors and methods specified here is glucose. However, contemplated analytes further include, but are not limited to, inflammatory markers, aldehydes, acarboxyprothrombin; acylcarnitine; adenine phosphoribosyltransferase; adenosine deaminase; Albumin; alpha-fetoprotein; amino acid profiles (arginine (Krebs cycle), histidine/urocanic acid, homocysteine, phenylalanine/tyrosine, tryptophan); andrenostendione; antipyrine; arabinitol enantiomers; arginase; benzoylecgonine; biotinidase; biopterin; C-reactive protein; carnitine; carnosinase; CD4; ceruloplasmin; chenodeoxycholic acid; chloroquine; cholesterol; cholinesterase; conjugated 1-β-hydroxycholic acid; cortisol; creatine kinase; creatine kinase MM isoenzyme; cyclosporine A; d-penicillamine; desethylchloroquine; dehydroepiandrosterone sulfate; DNA (acetylator polymorphism, alcohol dehydrogenase, alpha-1-antitrypsin, cystic fibrosis, Duchenne/Becker muscular dystrophy, analyte-6-phosphate dehydrogenase, hemoglobinopathies, A, S, C, E, D-punjab, beta-thalassemia, hepatitis B virus, HCMV, HIV—I, HTLV-I, liver hereditary optic neuropathy, MCAD, RNA, PKU, plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/Gal-1 phosphate; galactose-1-phosphate uridyltransferase; gentamicin; analyte 6-phosphate dehydrogenase; glutathione; glutathione peroxidase; glycocholic acid; glycated hemoglobin; halofantrine; hemoglobin variants; hexosaminidase A; human erythrocyte carboxylic acid anhydrase I; 17-alpha-hydroxyprogesterone; hypoxanthine phosphoribosyltransferase; immunoreactive trypsin; lactate; lead; lipoproteins; lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV—I, IgE (atopic disease), influenza virus, Leishmania donovani, Leptospira, measles/mumps/rubella, Mycobacterium leprae, Mycoplasma pneumoniae, myoglobin, Onchocerca volvulus, parainfluenza virus, Plasmodium falciparum, polio virus, Pseudomonas aeruginosa, respiratory syncytial virus, rickettsia (typhus), Schistosoma mansoni, Toxoplasma gondii, Trepenoma pallidium, Trypanosoma cruzi/rangeli, vesicular stomatitis virus, Wuchereria bancrofti, yellow fever virus); specific antigens (hepatitis B virus, HIV—I); succinylacetone; sulfadoxine; theophylline; thyrotropin (TSH); thyroxine (T4); thyroxine-binding globulin; trace elements; transferrin; UDP-galactose-4-epimerase; urea; uric acid; uroporphyrinogen I synthase; vitamin A; white blood cells; and zinc protoporphyrin; salts, sugars, protein, fat, vitamins, and hormones naturally found in blood, sweat, or in interstitial fluids may also be analytes in certain embodiments. The analyte may naturally be present in the biological liquid, for example a metabolite, a hormone, an antigen, an antibody and the like. The analyte may alternatively be introduced into the body, for example a contrast agent for imaging, a radioisotope, a chemical agent, a synthetic fluorocarbon-based blood or a medicament or a pharmaceutical composition including, but not limited to, pilocarpine, acetylcholine, bethanechol, metacholine carbachol, insulin; ethanol; cannabis (marijuana, tetrahydrocannabinol, hashish); inhalants (nitrous oxide, amyl nitrite, butyl nitrite, chlorohydrocarbons, hydrocarbons); cocaine (crack); stimulants (amphetamines, methamphetamines, Ritalin, Cylert, Preludin, Didrex, PreState, Voranil, Sandrex, Plegin); tranquilizers (barbiturates, methaqualone, tranquilizers such as Valium, Librium, Miltown, Serax, Equanil, Tranxen); hallucinogens (phencyclidine, lysergic acid, mescaline, peyot, psilocybin); narcotics (heroin, codeine, morphine, opium, meperidine, Percocet, Percodan, Tussionex, fentanyl, Darvon, TaIwin, Lomotil); designer drugs (analogues of fentanyl, meperidine, amphetamines, methamphetamines and phencyclidine, for example ecstasy); anabolic steroids and nicotine. The metabolites of drugs and pharmaceutical compositions are also regarded as analytes. Analytes such as neurochemicals and other chemicals produced in the body can also be analyzed, for example ascorbic acid, uric acid, dopamine, noradrenaline, 3-methoxytyramine (3MT), 3,4-dihydroxyphenylacetic acid (DOPAC), homovanilic acid (HVA), 5-hydroxytryptamine (5HT) and 5-hydroxyindoleacetic acid (FHIAA).

Further layers may also be applied to the surface, for example to allow access of a specific analyte.

It is also possible for only the interaction with the functional group, for example the carboxyl group, to be measured.

In a preferred embodiment the modified nanostructure is functionalized with an enzyme, preferably an oxidoreductase, in particular via the carboxyl group.

Oxidoreductases are capable of oxidizing or reducing an analyte (as a substrate) to release or consume electrons which can then be used to generate an electrical potential/current. As is known to those skilled in the art, oxidoreductase enzymes may be oxidases, dehydrogenases or hydrogenases. In one embodiment the oxidoreductase enzyme is an oxidase capable of oxidizing a carbohydrate substrate. As a nonlimiting example the oxidase enzyme may in a particular embodiment be glucose oxidase, cholesterol oxidase, amino acid oxidase, pyruvate oxidase, peroxidase, sarcosine oxidase, lactate oxidase, alcohol oxidase, monoamine oxidase, glycerol oxidase, glycerol phosphate oxidase, urate oxidase, xanthine oxidase, ascorbate oxidase. In a further embodiment the oxidoreductase enzyme may be a dehydrogenase such as for example pyrrolo-quinoline-quinone (PQQ) glucose dehydrogenase, D-fructose-5-dehydrogenase, glucose dehydrogenase, alcohol dehydrogenase, gluconate-2-dehydrogenase, laccase, bilirubin oxidase, ascorbate oxidase, aldehyde dehydrogenase, oxalate oxidase, malate dehydrogenase, succinate dehydrogenase, pyruvate dehydrogenase, glutamate dehydrogenase, isocitrate dehydrogenase or lactase dehydrogenase. As will be apparent to a person skilled in the art the choice of one or more enzymes may be influenced by the substrate on which the one or more enzymes act, the availability of the substrate and other aspects such as the desired environment of the electrically conductive ink. In one embodiment of the present invention the analyte may be a simple or complex carbohydrate such as for example, but not limited to, glucose, fructose, sucrose, trehalose, glycerol or an alcohol, for example methanol or ethanol. Other substrates are ethylene glycol, diethylene glycol, polyethylene glycol, diol, possibly cellulose, JP8-fuel, methane, butane and others. In a particular embodiment the enzyme is glucose oxidase.

In the detection reaction it is also possible to employ a mediator compound. The mediator compound may be selected from the group consisting of potassium ferricyanide, ferrocene derivatives, phenoxazine derivatives, phenothiazine derivatives, quinone derivatives and reversible redox transition metal complexes, particularly those of ruthenium and osmium, nicotinamide adenine dinucleotide (phosphate), diimines, phenanthroline derivatives, dichlorophenolindophenol tetrazolium dyes and phenylimino-benzophenoxazine.

Further details and features are apparent from the following description of preferred exemplary embodiments in conjunction with the subsidiary claims. The respective features may be realized alone or in a plurality in conjunction with one another. The options for solving the object are not limited to the exemplary embodiments. Thus for example, indicated ranges always comprise all—unlisted—intermediate values and all conceivable subintervals.

Further Details and Features are Apparent from the Following description of preferred exemplary embodiments in conjunction with the subsidiary claims. The respective features may be realized alone or in a plurality in conjunction with one another. The options for solving the object are not limited to the exemplary embodiments. Thus for example, indicated ranges always comprise all—unlisted—intermediate values and all conceivable subintervals.

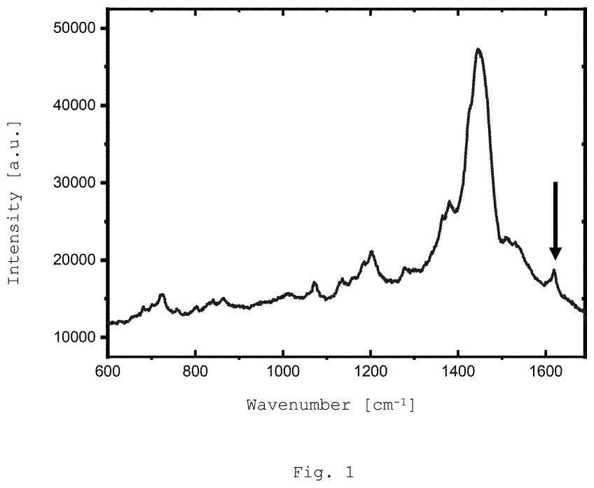

FIG. 1 Raman spectrum of the C₆-polymer-stabilized AuNPs after the coupling reaction with a PEG amine (methoxypolyethylene glycol amine, Mw=20 000 Da). At about 1615 cm⁻¹ a new band is formed wick is characteristic of the amide bond being formed (arrow);

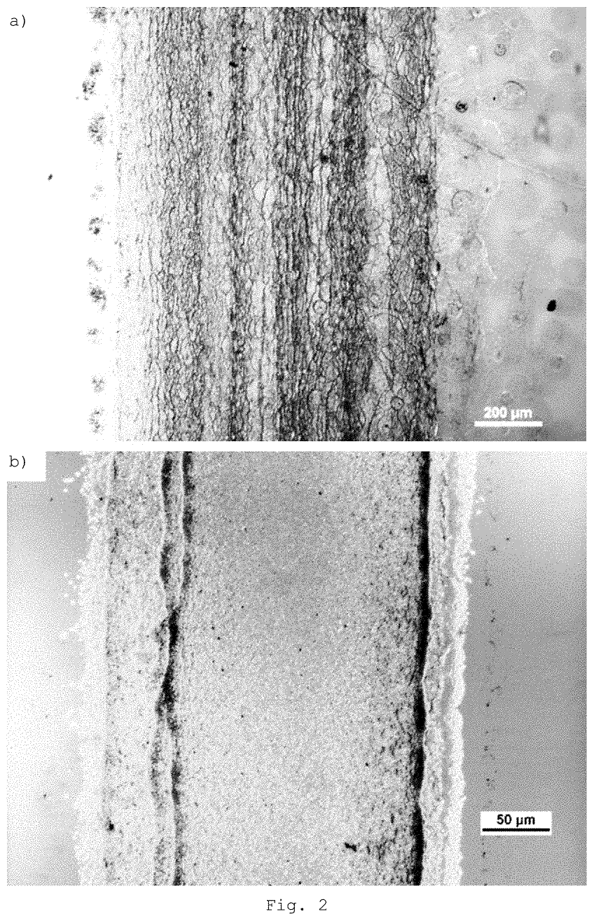

FIG. 2 Detail from a micrograph of a printed circuit board having dimensions of 10 mm×1 mm (a)), detail from a circuit board having a width of about 300 μm. This corresponds approximately to the width of one pixel (b));

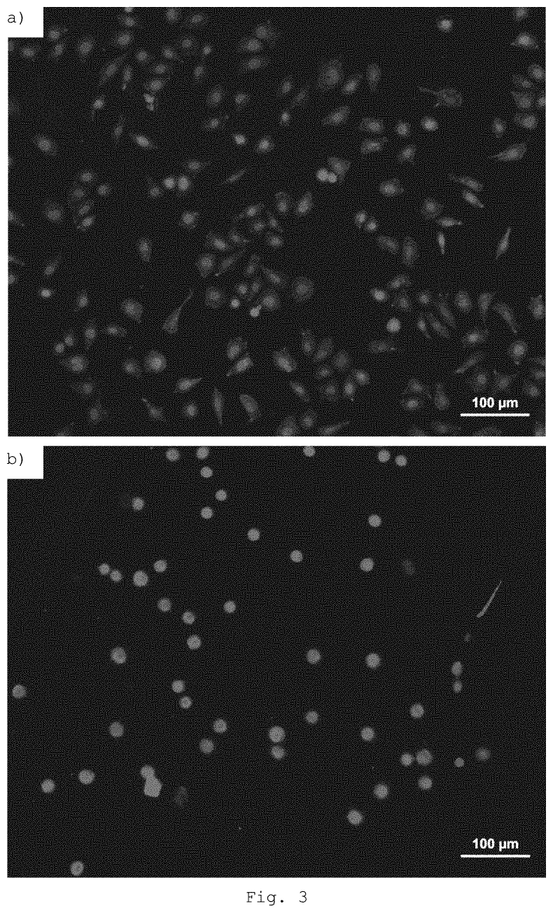

FIG. 3 Fibroblast cells on different conductive inks: 100% inventive ink: The cells grow on the substrate and start to spread (a)), 100% “normal” ink: Cells cannot grow and remain rounded (b));

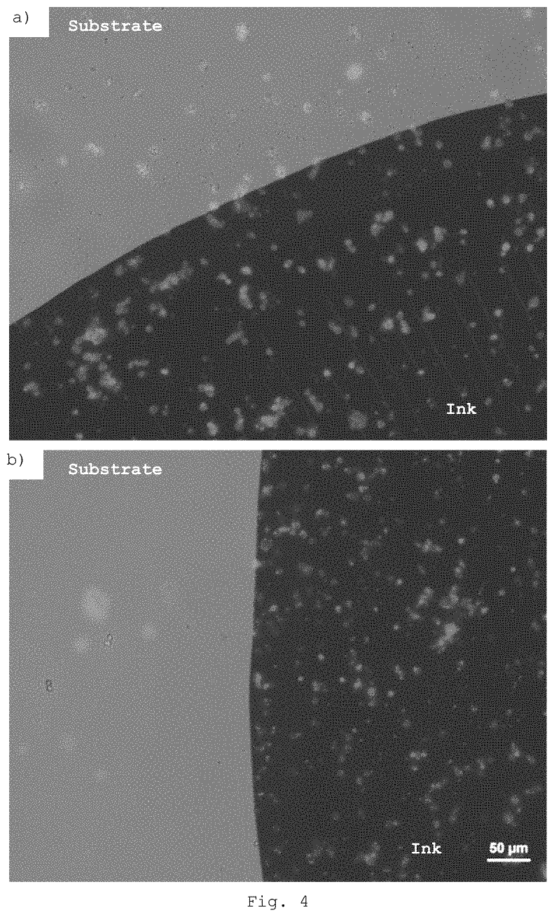

FIG. 4 Experiments with “Neurospheres”. The concentration of the neuropheres is significantly higher on the inventive ink than on the substrate.

### PRODUCTION OF THE INVENTIVE COMPOSITION

The polymers were obtained from Rieke Metals, USA. The nanostructures comprise CTAB as the ligand before the ligand substitution.

It was experimentally determined that the water solubility of the polymers reduces with increasing chain length of the side chains while simultaneously the stabilization capability increases as a result of the increasing steric demands. The tested C₆-polymer was the only polymer which simultaneously has sufficient solubility in water and can also stabilize the AuNPs (diameter 80 nm) (table 1). The polymers have a molecular weight of 55 000-65 000 g/mol.

For dissolution of the polymer, preferably of the C₆-polymer, in water certain conditions are preferably to be observed to ensure successful coating of the AuNPs:

Complete dissolution of the polymer without visible aggregate formation is required.

The dissolution operation of the C₆-polymer requires a duration of (12-24 h). Overnight dissolution is recommended. The temperature should be around room temperature or slightly above room temperature (20-35° C.).

Elevated temperatures above 50° C. lead to incomplete dissolution. Polymer aggregates can still be observed in solution even after 24 h. The elevated temperature apparently results in increased mobility and diffusion of the individual polymer strands. This favors interaction between the polymers and the formation of aggregates.

Ligand Substitution

In addition to the dissolution of the C₆-polymer, further conditions should be met to ensure complete coating of the AuNPs:

The coating of the AuNPs is carried out in aqueous solution with stirring for 7 days at a temperature >30° C. Excessively low temperatures favor agglomeration of the AuNPs during the coating operation.

An excessively short time (<7 days) does not allow full substitution of the original ligand with the C₆-polymer. The original ligand CTAB is still detectable by spectroscopic methods. This can lead to instabilities (agglomeration) of the AuNPs during workup of the finished ink.

By contrast, longer coating durations (>7 days) again favor the interaction between the free polymer strands that are not bound to the particles. The polymer strands in turn assemble into aggregates. This in turn has an adverse effect on the stability of the coated particles. In addition, aggregate formation hampers the removal of the excess (unbound polymer) from the solution by centrifugation.

Purification

Centrifugation may be use to remove the excess C₆-polymer that remains in the solution after the coating process and is not bonded to the AuNPs. This is decisive because excess C₆-polymer would reduce the conductivity of the resulting nanoparticle inks. Centrifugation also allows the ink to be concentrated and the solvent to be changed. The centrifugation parameters (time and speed) were optimized to avoid agglomeration of the particles. It has been found that excessive speeds result in agglomeration of the particles. The C₆-polymer-stabilized particles were found to be stable during centrifugation up to a speed of 1000 rpm. Long centrifugation times (4-15 h, depending on rpm <1000 rμm) were required to ensure complete separation of the particles from the excess C₆-polymer.

However, the stability of the C₆-Polymer-stabilized AuNPs during centrifugation was improved by addition of 0.05% by weight of the surfactant (Tween 20). This made it possible to centrifuge at faster speeds and thus substantially reduce the centrifugation time.

A speed of 2000 rpm for 3 h were found to be optimal centrifugation parameters. Obtaining a fully purified (no excess free C₆-polymer in solution) and highly concentrated (100 mg/ml) ink requires five centrifugation steps. In the last centrifugation step no further surfactant Tween 20 is added, only pure solvent. The last centrifugation step thus not only removes further C₆-polymer but also washes out the surfactant which would otherwise have adverse effects on the conductivity of the finished ink. A filter operation (PES filter, pore size Ø=0.22 μm) after the first centrifugation step can facilitate the separation of the excess C₆-polymer.

Measurement of the coating of the nanoparticles with the polymer C₆-polymer (PTEBS) was done using thermogravimetric Analysis (TGA). A proportion of 1.38% by weight (about 13% by volume) was determined. This results in a ligand density of 3.6 mg/m². Other higher molecular weight conductive polymers applied to the same gold particles resulted in a ligand density of 1.8-1.9 mg/m². The concentration ratio of polymer to gold during the ligand substitution was the same at 0.8:1 (based on mass concentration) for all polymers during the ligand substitution. The calculated thickness of the polymer layer for the inventive particles is on average 1.76 nm which is markedly greater than the thickness of the polymers of 0.9 nm. The pi-pi interaction distance of polythiophenes is 0.37-0.39 nm. This has the result that in the case of PTEBS 4-5 polymer layers surround the particles. The first polymer layer is directly bonded to the gold particle. The remaining layers are attached via pi-pi interactions.

Before the ligand substitution the nanoparticles have a zeta potential of +31.6 mV in water. After the ligand substitution the zeta potential is −36.1 mV (in water). The C₆-polymer is soluble only in water alone and not in alcohols. Surprisingly, the nanoparticles functionalized with the polymer are stable in alcohols. Alcohols are preferred solvents for inks since the reduced surface tension results in improved wetting and thus facilitates inkjet printing. The best results were obtained with n-propanol. Structures were obtained with isopropanol and ethanol but the print quality was lower. No gaps must be formed by dewetting during printing, since otherwise conductivity is reduced.

The particles are colloidally stable in alcohols. The zeta potential is −24.4 mV in n-propanol.

The stores the particles may be kept in water which reduces the risk of drying out.

Functionalization

To demonstrate the covalent bonding of bioactive molecules to the AuNPs stabilized with C₆-polymer (table 1) an exemplary amine (methoxypolyethylene glycolamine, Mw=20 000 Da) was coupled to the particles of bio-ink in solution. The covalent bonding is effected by the formation of an amide bond. This newly formed amide bond may be detected by Raman spectroscopy. Amides have a characteristic band in the range of 1500-1700 cm⁻¹. The Raman spectrum of the ink particles coupled with PEG amines exhibit a new band in this range which was not detectable prior to the coupling reaction (see FIG. 1). The results of Raman spectroscopy thus confirm the covalent bonding of the amine to the C₆-polymer-stabilized AuNPs.

Printing

It was possible to produce inks having a high concentration of gold nanoparticles which were processable by inkjet printing. Solvents may be selected from various inorganic and organic substances such as for example water, ethanol, propanol etc. The solvent should be selected according to the substrate, thus allowing sufficient wetting to be achieved. Substrates may be employed include various materials such as paper, glass or various plastic films such as PET, PDMS, TPU etc.

A glass slide coated with a thin layer of hydrogel was used as the substrate in the experiments. A diamine was then attached to the hydrogel via a chemical reaction, said diamine being bonded to the hydrogel via an amide bond.

The ink was then applied to the substrate using an ink jet printer. The printing properties of the ink depend on the solvent, wherein the use of n-propanol has proven particularly suitable since it markedly reduces blocking of the nozzle. The use of n-propanol is also suitable having regard to the substrate used. The inkjet printer makes it possible to produce any desired patterns. FIG. 2 shows detail views of various printed lines.

The ink may subsequently be coupled to the substrate via an amide bond provided that the substrate has —NH₂ groups. This prevents possible detachment of the ink from the substrate during subsequent cell experiments.

The conductivity in aqueous cell cultivation media was investigated. In a slightly acidic environment (MES buffer, pH=6.1) and in a slightly basic environment (PBS buffer, pH=7.4). The measured layer resistance (typically 100-500Ω/□) changed by less than 3% compared to the dry film over 8 hours.

The inks used were formulated in alcohols, mostly n-propanol, and had a gold content of 100-150 mg/ml.

Cell Experiments

In order to check to what extent the interaction between the inventive ink and cells differs from the “normal” ink and cells, the following experiments were performed:

The ink was mixed with different amounts of the normal ink (100:0; 80:20; 50:50, 20:80, 0:100). The ink was applied to the substrate by drop-casting. Once the ink had dried, RGD, a peptide that enables adhesion of fibroblast cells and has the sequence Arg-Gly-Asp (SEQ ID No. 1), was applied to the ink. RGD can be covalently bonded to the inventive ink but not to the conventional ink. The specimen was subsequently washed and cell experiments performed. The results showed (FIG. 3) that the fibroblasts can only grow (visible by the spreading of the cells) on inks comprising a high proportion of the inventive ink (at least 80%). The cells did not grow on the other inks. This results shows that the growth of the fibroblasts on the inventive ink is brought about by the peptide RGD that is covalently bonded to the ink and does not just take place on account of an unspecific interaction (for example adsorption processes).

In a further experiment the peptide IK-19 (CSRARKQAASIKVAVSADR, SEQ-ID No. 2) was covalently bonded to the ink instead of RGD. In contrast to RGD, fibroblasts showed no response to IK-19. Neurons, on the other hand, responded to the IK-19 with improved growth.

A first experiment with so-called “neurospheres” was also carried out. To this end, 100% bio-inks based on different solvents were tested: a) n-propanol and b) water comprising 0.05% by volume of Tween 20. The peptide IK-19 was coupled to both inks after drop casting. The cell experiments showed a markedly higher concentration of neurons on the ink spot relative to the substrate (see FIG. 4). This suggests that the neurons are present to a greater extent where the IK-19 is located. To summarize, the experiments show that the neurons grow onto the printed ink to a much greater extent in the presence of the peptide IK-19. It was shown for both cell types (fibroblasts and neurons) that covalent bonding of a peptide to the ink is decisive for the differentiation of the cells.

TABLE 1

| | | water | Stabilization |
|---|---|---|---|
| Name/Abbreviation | Structure | solubility | of AuNPs |
| Poly[3-(potassium-4- butanoate)thiophene- 2,5-diyl]/C₄- polymer | 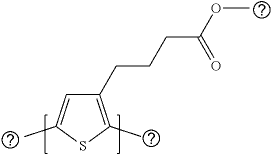 | + | − |
| Poly[3-(potassium-5- pentanoate)thiophene- 2,5-diyl]/C₅- polymer | 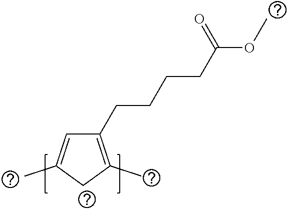 | + | − |
| Poly[3-(potassium-6- hexanoate)thiophene- 2,5-diyl]/C₆- polymer | 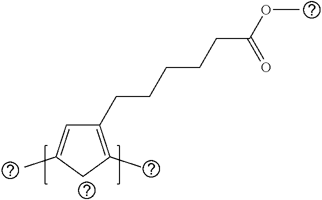 | + | + |
| Poly[3-(potassium-7- heptanoate)thiophene- 2,5-diyl]/C₇- polymer | 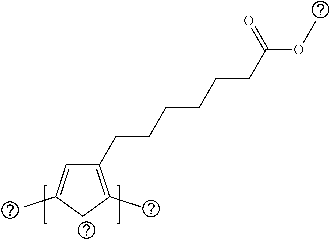 | − | + |

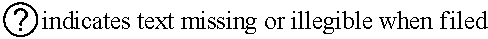

1. A composition for producing conductive or semiconductive layers by wet coating, comprising:
at least one type of conductive or semiconductive nanostructures, wherein at least one conductive ligand is arranged on a surface of the nanostructures;
at least one solvent, wherein the ligand has at least one functional group by which functionalization is possible.

2. The composition as claimed in claim 1, wherein the ligand is a conductive polymer or oligomer based on thiophene.

3. The composition as claimed in claim 1, wherein the at least one conductive ligand comprises a polymer or oligomer having at least 10 bonding sites for achieving a coordinative bond to the surface of the nanostructure.

4. The composition as claimed in claim 1, wherein at least one type of conductive or semiconductive nanostructure comprises a metallic nanostructure.

5. The composition as claimed in claim 1, wherein the at least one functional group is a functional group of a side chain.

6. The composition as claimed in claim 1 the functional group is a carboxyl group.

7. The composition as claimed in claim 1, wherein the at least one solvent comprises solvents or mixtures of solvents each having a boiling point below 120° C.

8. The composition as claimed in claim 2, wherein the conductive polymer is a thiophene having as a functional group an aliphatic chain having 3 to 8 carbon atoms and a carboxyl group, wherein the carboxyl group counts as a carbon atom.

9. A process for producing a functionalized conductive or semiconductive layer on a surface comprising:
a) application of a composition as claimed in claim 1 to a surface;
b) removal of the at least one solvent; and
c) functionalization of the composition.

10. The process as claimed in claim 9, wherein the process comprises no treatment of a coating at temperatures of more than 60° C. after the application to the surface.

11. A functionalized conductive or semiconductive structure obtained by the process as claimed in claim 9.

12. A process for producing a composition as claimed in claim 1, comprising:
provision of a dispersion of conductive or semiconductive nanostructures, wherein the dispersion is stabilized by at least one first ligand;
addition of at least one conductive ligand; and
substitution of the first ligand by the at least one conductive ligand to obtain a modified nanostructure.

13. The process as claimed in claim 12, wherein the modified nanostructure is purified by one or more centrifugations.

14. The process as claimed in claim 13, wherein at least one centrifugation is preceded by addition of a surfactant.

15. The process as claimed in claim 14, wherein the surfactant is added in an amount of 0.02% to 0.1% by weight.

16. A modified nanostructure obtained by the process as claimed in claim 12.


SEQUENCE LISTING (2 sequences)

SEQ ID NO: 1 - protein, 3 aa, artificial sequence
  synthetic sequence
RGD

SEQ ID NO: 2 - protein, 19 aa, artificial sequence
  synthetic sequence
CSRARKQAASIKVAVSADR